(19) United States
(12) Patent Application Publication
(10) Pub. No.: US 2023/0030965 A1
(43) Pub. Date: Feb. 2, 2023

(54) Hoverboard Attachment

(71) Applicant: Liqin Xu, Waxahachie, TX (US)

(72) Inventor: Liqin Xu, Waxahachie, TX (US)

(21) Appl. No.: 17/502,407

(22) Filed: Oct. 15, 2021

(30) Foreign Application Priority Data
Jul. 30, 2021 (CN) 202130488918.6
Aug. 5, 2021 (CN) 202121798586.2

(51) Int. Cl. B62J 11/00; F16B 2/12

(52) U.S. Cl. CPC B62J 11/00; F16B 2/12

(57) ABSTRACT

This utility model relates to a kind of self-balancing scooter accessory connecting structure and accessory, comprising at least a clamping mechanism used to clamp the driving parts. The said clamping mechanism comprises the 1^{st} gripper and the 2^{nd} gripper. The said 1^{st} gripper and the 2^{nd} gripper may be mounted in a way permitting relative motion. The said 1^{st} gripper comprises the 1^{st} connection and 1^{st} clamp plate. The said 2^{nd} gripper comprises the 2^{nd} connection and 2^{nd} clamp plate; a self-locking structure, comprising the limit stops and length adjustment mechanism. The said 1^{st} connection and 2^{nd} connection are equipped with the said limit stop. The said length adjustment mechanism is mounted between two limit stops. The above self-balancing scooter accessory connecting structure is mounted between the self-balancing scooter saddle and driving parts. The 1^{st} clamp plate and the 2^{nd} clamp plate structures are suitable for fastening the driving parts without use of straps. This approach can eliminate safety hazards on velcro strap's susceptibility to breakdown, and make assembly and disassembly more efficiently.

### TECHNICAL FIELD

This utility model provides a product for use in the transportation and amusement equipment area, specifically a kind of self-balancing scooter accessory connecting structure and accessory.

### TECHNICAL BACKGROUND

The electric self-balancing scooter (also known as SCV (sensor controlled vehicle) is an outcome of science and technology development. It is an environment-friendly product serving as a means of transport and entertainment. For the purpose of meeting people's entertainment needs and operation experience, some products featuring the combined function and structure of motor-driven electric self-balancing scooter (particularly, two-wheel self-balancing scooter, hoverboard) and motor-driven karting have been manufactured. These products are basically rear driven in a way that the accessory structure is always mounted in the back of the accessory (such as rear end) or underneath the seat to provide assembly space.

Generally, the width of connecting structure has to be adjusted to suit the self-balancing scooter of different sizes and facilitate assembly as well when the self-balancing scooter accessory is attached to the self-balancing scooter. However, the existing connecting structure attaching the self-balancing scooter accessory to the self-balancing scooter is fabricated in a way designed for width adjustment via screw locking. It is not easy to complete the entire attaching process as an additional wrench is used for locking, followed by use of tie-down strap. Once the wrench is missing, locking is impossible. The velcro strap prone to breakdown constitutes a safety hazard on proper operation of karting.

### Contents of Utility Model

Therefore, it is necessary to provide a self-balancing scooter accessory connecting structure able to facilitate installation and address safety concerns.

This invention provides a kind of self-balancing scooter accessory connecting structure, which comprises at least one clamping mechanism used to clamp driving parts. The said clamping mechanism comprises:

The 1^{st} gripper and the 2^{nd} gripper. The said 1^{st} gripper and the 2^{nd} gripper may be mounted in a way permitting relative motion. The said 1^{st} gripper comprises the 1^{st} connection and 1^{st} clamp plate. The said 2^{nd} gripper comprises the 2^{nd} connection and 2^{nd} clamp plate;

A self-locking structure, comprising the limit stops and length adjustment mechanism. The said 1^{st} connection and 2^{nd} connection are equipped with the said limit stop. The said length adjustment mechanism is mounted between two limit stops.

The proposed invention is technically detailed below:

An embodiment shows that there are two said clamping mechanisms. A removable connecting rod is provided between two said clamping mechanisms.

An embodiment shows that the said 1^{st} clamp plate comprises the connecting plate attached to the said 1^{st} connection as well as the fixture. The said 2^{nd} clamp plate comprises the connecting plate attached to the said 2^{nd} connection as well as the fixture. Two said connecting plates are mounted relative to the appropriate fixtures at an obtuse included angle.

An embodiment shows that elastic cushions are mounted at a side where the said 1^{st} clamp plate and 2^{nd} clamp plate are in contact with the said driving parts.

An embodiment shows that a slide rail is mounted in either the said 1^{st} connection or the 2^{nd} connection. Then, the connection without slide rail is subject to slip connection to the said slide rail.

An embodiment shows that the said slide rail is an integral part of the said 1^{st} connection or the 2^{nd} connection. The said slide rail is connected to the margin of the said 1^{st} connection or 2^{nd} connection in a folding way.

An embodiment shows that the said length adjustment mechanism comprises a quick release screw and a handle. The said quick release screw secures two said limit stops. The screw holes sized to suit the said quick release screw are provided in two limit stops.

An embodiment shows that the said length adjustment mechanism also comprises a handle. The said handle is hinged to the said quick release screw via an axis. The said axis is vertically mounted relative to the said quick release screw.

An embodiment shows that a stiffener is provided at each outside of the said 1^{st} clamp plate and 2^{nd} clamp plate.

The above self-balancing scooter accessory connecting structure is typically mounted between the self-balancing scooter accessory and driving parts. The self-balancing scooter-powered driving parts are fastened through movement of the 1^{st} clamp plate 112 relative to the 2^{nd} clamp plate 122 as well as their intrinsic structures without use of straps. This approach can eliminate safety hazards on velcro strap's susceptibility to breakdown, and make assembly and disassembly more efficiently.

Specifically, when the accessory has to be mounted on the driving parts, remove the quick release screw with the handle to allow the 1^{st} gripper and 2^{nd} gripper to move along the slide rail. When this motion comes to a level at which the clearance between the 1^{st} clamp plate and 2^{nd} clamp plate is larger than the driving parts, put the driving parts between the 1^{st} clamp plate and 2^{nd} clamp plate. Move back the 1^{st} gripper and 2^{nd} gripper along the slide rail. When two limit stops are put in position with the quick release screw, fasten the quick release screw with the handle to complete the entire assembly. Later, the 1^{st} clamp plate and 2^{nd} clamp plate can properly come in contact with the external surface of driving parts with use of elastic cushions to benefit fastening. This type of assembly can fasten the 1^{st} gripper and 2^{nd} gripper with the supplied handle rather than other tools not attached to the connecting structure. Thus, it is easy to complete assembly and disassembly whenever required without concern about lack of spare tools.

Furthermore, this invention also provides a kind of accessory, which comprises any self-balancing scooter accessory connecting structure feature as mentioned above.

### DESCRIPTION OF FIGURES

The figures as part of this invention serve for further interpretation of this utility model. This utility model is illustrated via schematic embodiments and descriptions. These schematic embodiments and descriptions do not constitute inadequate restrictions to this utility model.

To technically outline the embodiments of this utility model, the figures necessary to describe the embodiments are briefed below. Obviously, these figures only relate to some embodiments of this utility model. Common design staff in this area may obtain additional figures by learning these figures without creative work.

FIG. 1 outlines the self-balancing scooter accessory connecting structure as shown in an embodiment of this utility model;

FIG. 2 is an enlarged drawing at Area A of FIG. 1;

FIG. 3 is FIG. 1's side view;

FIG. 4 is FIG. 1's rear view.

### DESCRIPTION OF FIGURE SIGNS

100, clamping mechanism; 110, 1^{st} gripper; 111, 1^{st} connection; 112, 1^{st} clamp plate; 120, 2^{nd} gripper; 121, 2^{nd} connection; 122, 2^{nd} clamp plate; 130, connecting plate; 140, fixture; 150, elastic cushion; 160, slide rail; 170, limit stop; 180, length adjustment mechanism; 181, quick release screw; 182, handle; 1821, hinged end; 1822, gripping end; 183, axis; 190, stiffener; 200, connecting rod.

### DETAILED DESCRIPTION OF THE PREFERRED EMBODIMENTS

To allow the above intentions, characteristics and advantages of this utility model to be easily understood, this utility model is illustrated with figures below to describe the mode of carrying out the invention. For this purpose, details are used to facilitate understanding of this utility model. On the other hand, this utility model may be implemented in different modes not mentioned here. Technical staff in the area may make improvement provided the connotation of this utility model is followed. Therefore, this utility model is not limited to the embodiments as described below.

An appropriate mode of implementing this utility model is illustrated below.

The embodiment in this invention provides a kind of accessory. Specifically, it refers to a karting accessory arising from modification of the self-balancing scooter. The retrofitted karting is self-balancing scooter-driven. The accessory and self-balancing scooter connection is illustrated in the embodiment below.

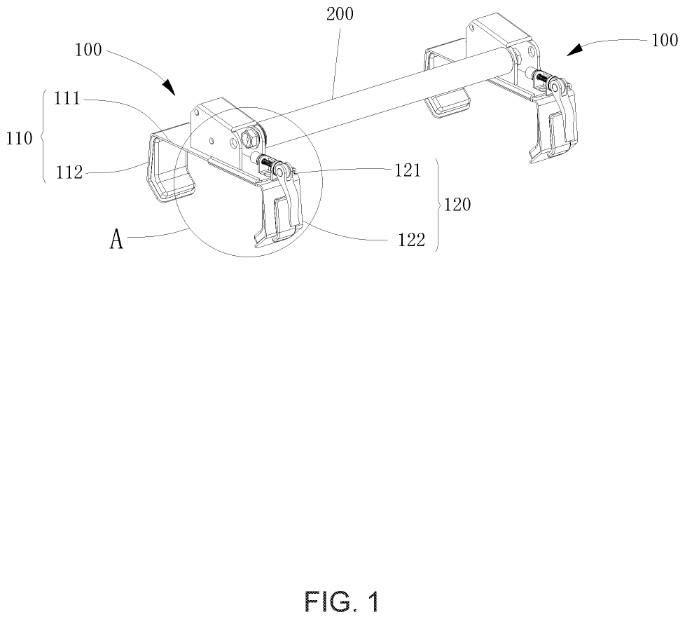

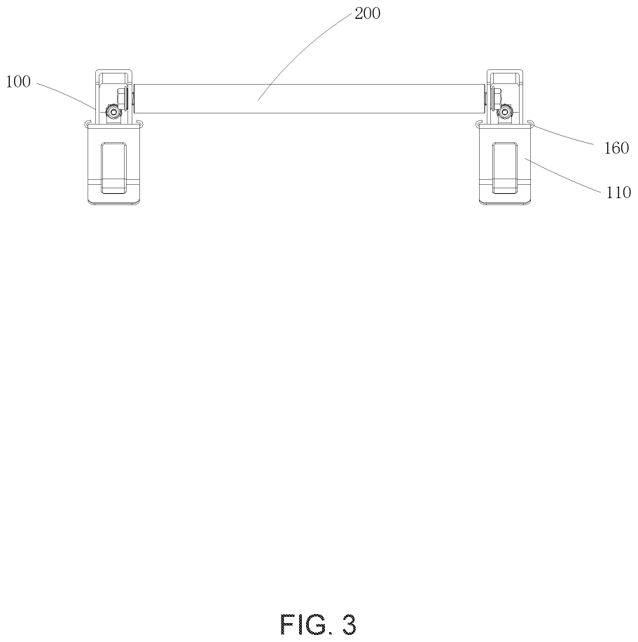

As illustrated in FIG. 1-4, an embodiment in this invention relates to a kind of self-balancing scooter accessory connecting structure, which comprises at least one clamping mechanism 100 used to clamp driving parts. The clamping mechanism 100 comprises the 1^{st} gripper 110 and the 2^{nd} gripper 120. The said 1^{st} gripper 110 and the 2^{nd} gripper 120 may be mounted in a way permitting relative motion. The said 1^{st} gripper 110 comprises the 1^{st} connection 111 and 1^{st} clamp plate 112. The 2^{nd} gripper 120 comprises the 2^{nd} connection 121 and 2^{nd} clamp plate 122. The 1^{st} clamp plate 112 is mounted in an opposite side of the 2^{nd} clamp plate 122. A self-locking structure comprises the limit stops 170 and length adjustment mechanism 180. The 1^{st} connection 111 and 2^{nd} connection 121 are each equipped with one limit stop 170. The length adjustment mechanism 180 is mounted between the two limit stops 170.

It is noted that the 1^{st} gripper 110 and the 2^{nd} gripper 120 are mounted in a way permitting relative motion so as to increase or reduce the distance between the 1^{st} clamp plate 112 and the 2^{nd} clamp plate 122. Thus, it is possible to suit the width of different driving parts by adjusting the relative position of the 1^{st} clamp plate 112 and 2^{nd} clamp plate 122.

It is noted that two limit stops 170 are all integral part of the 1^{st} connection 111 and 2^{nd} connection 121, or secured to them. It is possible to vary the distance between the 1^{st} clamp plate 112 and 2^{nd} clamp plate 122 by adjusting the distance of the two limit stops 170.

The above self-balancing scooter accessory connecting structure is typically mounted between the self-balancing scooter saddle and driving parts. The self-balancing scooter-powered driving parts are fastened through movement of the 1^{st} clamp plate 112 relative to the 2^{nd} clamp plate 122 as well as their intrinsic structures without use of straps. This approach can eliminate safety hazards on velcro strap's susceptibility to breakdown, and make assembly and disassembly more efficiently.

Proceed to FIGS. 1, 3 and 4. Specifically, there are two clamping mechanisms 100. A removable connecting rod 200 is provided between the two clamping mechanisms 100. Two clamping mechanisms 100 are separately working on two foot-pedals of the self-balancing scooter. The connecting rod 200 between clamping mechanisms 100 is used for accessory connection.

Proceed to FIG. 1-4. Specifically, the 1^{st} clamp plate 112 comprises the connecting plate 130 and fixture 140 attached to the 1^{st} connection 111, and the 2^{nd} clamp plate 122 comprises the connecting plate 130 and fixture 140 attached to the 2^{nd} connection 121. Each connecting plate 130 is mounted relative to the appropriate fixture 140 at an obtuse included angle. The obtuse contour joining the connecting plate 130 and fixture 140 cannot only protect the fastened driving parts from disengagement, but also facilitate assembly so that it is well adjusted to suit different driving parts of varying thickness.

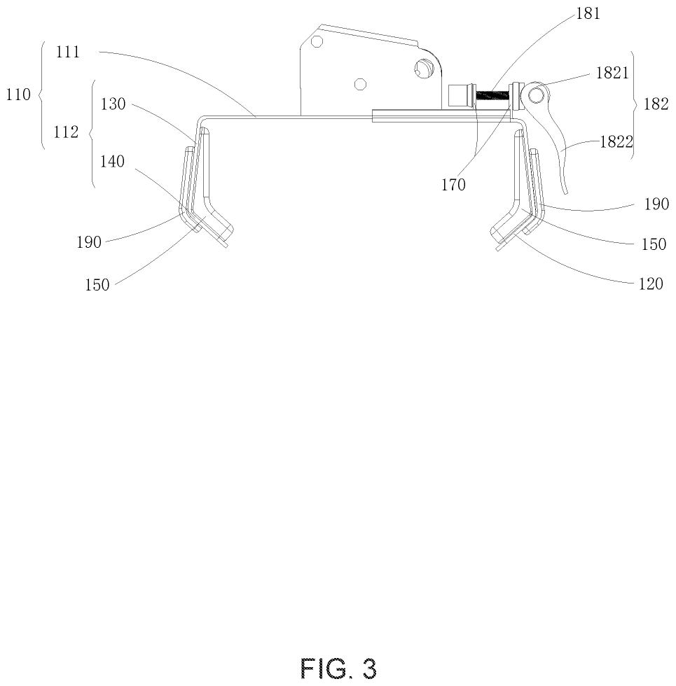

Refer to FIG. 3 for more details. Two connecting plates 130 obliquely extend in a direction apart from each other. Two fixtures 140 obliquely extend in a direction toward each other. Combination of the 1^{st} gripper 110 with the 2^{nd} gripper 120 forms a “C-like” claw hook construction in the side, through which the clamping mechanism 100 can catch the driving parts to protect them from disengagement. More specifically, following the slide direction of the 1^{st} clamp plate 112 relative to the 2^{nd} clamp plate 122 (left and right direction in FIG. 3), two connecting plates 130 skew outwards, thus providing a large clamping space. Furthermore, two fixtures 140 skew inwards to a level that an entrance smaller than the above clamping space is formed between the ends of two fixtures 140. As a result, two fixtures 140 can catch the driving parts to protect them from disengagement.

Proceed to FIG. 1-4. Specifically, elastic cushions 150 are mounted at each side where the 1^{st} clamp plate 112 and 2^{nd} clamp plate 122 are exposed to the driving parts to allow the 1^{st} clamp plate 112 and 2^{nd} clamp plate 122 to come in contact with the driving parts. The elastic cushions 150, when being clamped, are tensioned at both sides. The side wall exposed to the driving parts can fully fit the side wall of driving parts, thus forming the self-balancing scooter's housing curvature, so that the 1^{st} clamp plate 112 and 2^{nd} clamp plate 122 can properly come in contact with the driving parts. Each elastic cushion 150 is mounted at the inner side of the 1^{st} clamp plate 112 and 2^{nd} clamp plate 122. The inner side in this embodiment refers to the side where the 1^{st} clamp plate 112 and 2^{nd} clamp plate 122 face the clamping space. Correspondingly, the outer side of the 1^{st} clamp plate 112 and 2^{nd} clamp plate 122 refers to the side opposite to the clamping space.

In this embodiment, the elastic cushion 150 may be a foam cushion. The structure clearance in the foam cushion is in a strategic position to allow the foam cushion to form the self-balancing scooter's housing curvature when the 1^{st} clamp plate 112 and 2^{nd} clamp plate 122 are fastened to the driving parts. Thus, the connection contour can properly come in contact with the driving parts.

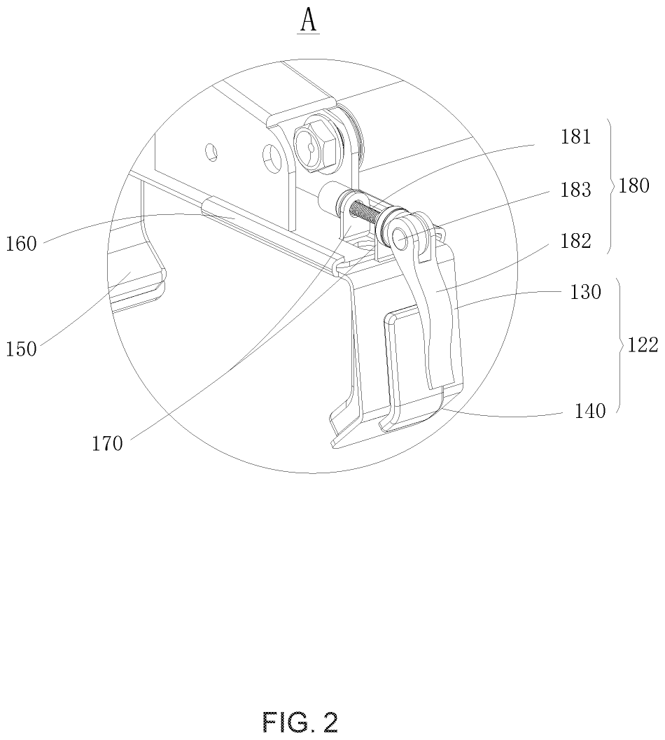

Proceed to FIG. 2-3. Specifically, the slide rail 160 is mounted in either the 1^{st} connection 111 or the 2^{nd} connection 121. Then, the connection without slide rail is subject to slip connection to the slide rail 160. For example, when the slide rail 160 is mounted in the 2^{nd} connection 121, the 1^{st} connection 111 is subject to slip connection to the slide rail 160. Alternatively, when the slide rail 160 is mounted in the 1^{st} connection 111, the 2^{nd} connection 121 is subject to slip connection to the slide rail 160.

This embodiment shows that the slide rail 160 is mounted in the 2^{nd} connection 121. Adjust the distance between the 1^{st} connection 111 and the 2^{nd} connection 121 by adjusting the position of 1^{st} connection 111.

Proceed to FIG. 1-3. Specifically, the slide rail 160 is an integral part of the 1^{st} connection 111 or 2^{nd} connection 121. The slide rail 160 is connected to the margin of the 1^{st} connection 111 or 2^{nd} connection 121 in a folding way. This embodiment shows that the slide rail 160 is connected to the margin of the 1^{st} connection 111 in a folding way when the slide rail 160 is mounted in the 1^{st} connection 111; that the slide rail 160 is connected to the margin of the 2^{nd} connection 121 in a folding way when the slide rail 160 is mounted in the 2^{nd} connection 121.

It is noted that an integrated structure mentioned here is not limited to the all-in-one structure, which may be fixed via welding.

Proceed to FIG. 2-3. Specifically, the length adjustment mechanism 180 comprises the quick release screw 181 and the handle 182. The quick release screw 181 secures two limit stops 170. The screw holes sized to suit the quick release screw 181 are provided in two limit stops 170. The quick release screw 181 is inserted into the screw hole of two limit stops 170. Adjust the length of quick release screw 181 by turning the handle 182 to vary the distance of two limit stops 170 so that the distance between the 1^{st} clamp plate 112 and the 2^{nd} clamp plate 122 can be adjusted.

Proceed to FIG. 2. Specifically, the handle 182 is hinged to the quick release screw 181 via the axis 183. The axis 183 is vertical to the quick release screw 181. The handle 182 can turn around the axis 183. When the desired distance between the 1^{st} clamp plate 112 and the 2^{nd} clamp plate 122 is reached, turn the handle 182 close to the 1^{st} clamp plate 112 or the 2^{nd} clamp plate 122 so that the self-balancing scooter accessory's exposure to unexpected objects can be avoided to eliminate safety hazards.

As illustrated in FIG. 3, this embodiment shows an eccentric handle 182. The eccentric handle has a hinged end 1821 in round contour, to be hinged to the quick release screw 181; and has the other gripping end 1822. In order to adjust the distance between the 1^{st} clamp plate 112 and the 2^{nd} clamp plate 122, hold the gripping end 1822 with hand to allow the eccentric handle to turn the quick release screw 181. Through the screw thread fit between the limit stops 170 and quick release screw 181, the distance between two limit stops 170 is reduced or increased, thus varying the distance between the 1^{st} clamp plate 112 and the 2^{nd} clamp plate 122. When the desired distance between the 1^{st} clamp plate 112 and the 2^{nd} clamp plate 122 is reached, turn the eccentric handle around the axis 183 to move the gripping end 1822 close to the 1^{st} clamp plate 112 or the 2^{nd} clamp plate 122. The hinged end 1821 presses against the limit stops 170 to lock the limit stops 170.

It is noted that the eccentric handle is eccentrically mounted at the hinged end. Specifically, when the gripping end 1822 approaches the 1^{st} clamp plate 112 or 2^{nd} clamp plate 122, the distance between the axis 183 and the outer contour of the hinged end 1821 is more than that between the axis 183 and the outer contour of the hinged end 1821 when the gripping end 1822 is parallel to the quick release screw 181. Furthermore, when the gripping end 1822 approaches the 1^{st} clamp plate 112 or 2^{nd} clamp plate 122, the hinged end 1821 reaches the limit stops 170. When the gripping end 1822 is parallel to the quick release screw 181, the hinged end is in clearance fit with the limit stops 170. Thus, as the gripping end 1822 is pressed down toward the 1^{st} clamp plate 112 or the 2^{nd} clamp plate 122, the hinged end 1821 presses against the limit stops 170, thus locking the limit stops 170.

Proceed to FIG. 1-3. Specifically, each stiffener 190 is mounted at the outer side of the 1^{st} clamp plate 112 and the 2^{nd} clamp plate 122 to prevent the 1^{st} clamp plate 112 and the 2^{nd} clamp plate 122 from sustaining excessive load or breakdown as a result of enduring tension. More specifically, the stiffener 190 may be made of the same material as the 1^{st} clamp plate 112 and the 2^{nd} clamp plate 122, and an integral part of the 1^{st} clamp plate 112 or the 2^{nd} clamp plate 122.

More specifically, when the accessory has to be mounted on the driving parts, remove the quick release screw 181 with the handle 182 to allow the 1^{st} gripper 110 and 2^{nd} gripper 120 to move along the slide rail 160. When the motion comes to a level at which the clearance between the 1^{st} clamp plate 112 and 2^{nd} clamp plate 122 is larger than the driving parts, put the driving parts between the 1^{st} clamp plate 112 and 2^{nd} clamp plate 122. Move back the 1^{st} gripper 110 and 2^{nd} gripper 120 along the slide rail 160. When two limit stops 170 are put in position with the quick release screw 181, fasten the quick release screw 181 with the handle 182 to complete the entire assembly. Later, the 1^{st} clamp plate 112 and 2^{nd} clamp plate 122 can properly come in contact with the external surface of driving parts with use of elastic cushions 150 to benefit fastening. This assembly allows to turn the quick release screw 181 with the supplied handle 182, and then fastens the 1^{st} gripper 110 and 2^{nd} gripper 120 without use of other tools not attached to the connecting structure. Thus, it is easy to complete assembly and disassembly whenever required without concern about lack of spare tools.

The features of the above embodiments can be technically combined in any way. For the purpose of concise description, not all combinations of these features available with the above embodiments are covered. However, combination of these features should be included in this Instruction provided such combination is justifiable.

The above descriptions on embodiments only illustrate how this utility model is implemented, which, however, should not be regarded as restriction to this utility model's Claims even though there are concrete and detailed descriptions. It is noted that this utility model is subject to variation and improvement by common technical staff in this area provided the fundamental idea of this utility model is followed. Such variation and improvement are within the protection of this utility model. Thus, for this utility model's scope of patent protection, the attached Claims may apply.

It is noted that in the description of this utility model, such terms on orientation or position as “Center”, “Longitudinal”, “Transverse”, “Length”, “Width”, “Thickness”, “Above”, “Below”, “Front”, “Rear”, “Left”, “Right”, “Vertical”, “Horizontal”, “Top”, “Bottom”, “Internal”, “External”, “Clockwise”, “Counterclockwise”, “Axial”, “Radial”, “Circumferential”, etc. are used based on the orientation or position as shown in the drawings. These terms are used only for simplified description of this utility model rather than explicit or implied indication that related units or devices should be positioned, constructed and operated at specific orientation. Thus, it shall not be regarded as restriction to this utility model.

Furthermore, the term “1^{st}” and “2^{nd}” is only used for description purpose, which shall not be regarded as explicit or implied relative importance or implied indication of quantity of specific technical features. Thus, for any feature limited to “1^{st}” and “2^{nd}”, at least one such feature may be contained in an explicit or implied manner. In the description of this utility model, “Several” means at least two, for example, two, three, etc. unless otherwise stated.

Such terms as “Assembly”, “Connection”, “Junction”, “Fastening”, etc. used for this utility model should be understood in a broad sense unless otherwise stated. For example, it may be permanent connection, or removable connection, or an integral part; possibly mechanical connection, or electrical connection; possibly direct connection, or indirect connection via intermediary, or connectivity inside two components or interaction of two components, unless otherwise specified. Common technical staff in this area may define the exact meaning of these terms in this utility model on a case-by-case basis.

Unless otherwise stated in the description of this utility model, the fact that the 1^{st} feature is “Above” or “Below” the 2^{nd} feature may refer to the direct contact of the 1^{st} feature and the 2^{nd} feature, or the 1^{st} feature and the 2^{nd} feature are in an indirect contact via intermediary. Furthermore, the 1^{st} feature is “Above” or on the “Top” of the 2^{nd} feature, meaning that the 1^{st} feature is just above or on the inclined top of the 2^{nd} feature, or only indicating that the 1^{st} feature is above the 2^{nd} feature in terms of horizontal elevation. The 1^{st} feature is “Below” or at the “Bottom” of the 2^{nd} feature, meaning that the 1^{st} feature is just underneath or at the inclined bottom of the 2^{nd} feature, or only indicating that the 1^{st} feature is below the 2^{nd} feature in terms of horizontal elevation.

It is noted that when a component is described to be “fixed” or “set” on another component, it may be directly mounted on another component or there may be a middle component. When a component is regarded to be “Connected” to another component, it may be directly connected to another component or there may be a middle component simultaneously. Such terms as “Vertical”, “Horizontal”, “Above”, “Below”, “Left”, “Right” as well as similar expressions used here are for description only rather than indicating the only means of implementation.

1. A self-balancing scooter accessory connecting structure, comprising at least one clamping mechanism used to clamp driving parts, wherein the clamping mechanism comprises:
a first gripper and a second gripper, wherein the first gripper and the second gripper can be mounted in a way permitting relative motion, wherein the first gripper comprises a first connection and a first clamp plate, and wherein the second gripper comprises a second connection and a second clamp plate; and
a self-locking structure, comprising two limit stops and a length adjustment mechanism, wherein the first connection and the second connection are each equipped with one of the two limit stops, wherein the length adjustment mechanism is mounted between the two limit stops.

2. The self-balancing scooter accessory connecting structure of claim 1, comprising two clamping mechanisms, wherein a removable connecting rod is provided between the two clamping mechanisms.

3. The self-balancing scooter accessory connecting structure of claim 1, wherein the first clamp plate comprises a connecting plate attached to the first connection and a fixture, wherein the second clamp plate comprises the connecting plate attached to the second connection and the fixture, wherein the two connecting plates are mounted relative to the appropriate fixtures at an obtuse included angle.

4. The self-balancing scooter accessory connecting structure of claim 1, comprising elastic cushions mounted at a side where the first clamp plate and the second clamp plate are exposed to the driving parts.

5. The self-balancing scooter accessory connecting structure of claim 1, comprising a slide rail mounted in either the first connection or the second connection, and wherein when a connection is without a slide rail, the connection is subject to a slip connection to the slide rail.

6. The self-balancing scooter accessory connecting structure of claim 1, wherein the slide rail is an integral part of the first connection or the second connection; wherein the slide rail is connected to a margin of the first connection or the second connection in a folding way.

7. The self-balancing scooter accessory connecting structure of claim 1, wherein the length adjustment mechanism comprises a quick release screw, wherein the quick release screw secures the two limit stops, and wherein screw holes the are sized to suit the said quick release screw are provided in the two limit stops.

8. The self-balancing scooter accessory connecting structure of claim 1, wherein the length adjustment mechanism also comprises a handle, wherein the handle is hinged to the quick release screw via an axis, wherein the axis is vertically mounted relative to the quick release screw.

9. The self-balancing scooter accessory connecting structure of claim 1, wherein a stiffener is provided outside of the first clamp plate and the second clamp plate.

10. An accessory, comprising a self-balancing scooter accessory connecting structure as set forth in claim 1.

11. The accessory of claim 10, comprising two clamping mechanisms, wherein a removable connecting rod is provided between the two clamping mechanisms.

12. The accessory of claim 10, wherein the first clamp plate comprises a connecting plate attached to the first connection and a fixture, wherein the second clamp plate comprises the connecting plate attached to the second connection and the fixture, wherein the two connecting plates are mounted relative to the appropriate fixtures at an obtuse included angle.

13. The accessory of claim 10, comprising elastic cushions mounted at a side where the first clamp plate and the second clamp plate are exposed to the driving parts.

14. The accessory of claim 10, comprising a slide rail mounted in either the first connection or the second connection, and wherein when a connection is without a slide rail, the connection is subject to a slip connection to the slide rail.

15. The accessory of claim 10, wherein the slide rail is an integral part of the first connection or the second connection; wherein the slide rail is connected to a margin of the first connection or the second connection in a folding way.

16. The accessory of claim 10, wherein the length adjustment mechanism comprises a quick release screw, wherein the quick release screw secures the two limit stops, and wherein screw holes are sized to suit the said quick release screw are provided in the two limit stops.

17. The accessory of claim 10, wherein the length adjustment mechanism also comprises a handle, wherein the handle is hinged to the quick release screw via an axis, wherein the axis is vertically mounted relative to the quick release screw.

18. The self-balancing scooter accessory connecting structure of claim 1, wherein a stiffener is provided outside of the first clamp plate and the second clamp plate.
